(19) United States
(12) Patent Application Publication
(10) Pub. No.: US 2002/0023096 A1
(43) Pub. Date: Feb. 21, 2002

(54) E-marker E-mailer

(76) Inventor: Yuichiro Deguchi, San Mateo, CA (US)

Correspondence Address: Seong-Kun Oh, Sierra Patent Group, P.O. Box 6149, Stateline, NV, 89449, US

(21) Appl. No.: 09/932,663

(22) Filed: Aug. 17, 2001

(30) Foreign Application Priority Data
Jul. 24, 2000 (JP) 2000-221686

(51) Int. Cl. G06F 7/00

(52) U.S. Cl. 707/104.1; 707/1

(57) ABSTRACT

Method and system for exchanging bookmarked music clip information between electronic music marker device users by generating and transmitting an electronic mail message with user's bookmarked music clip information to a user defined group of other electronic music marker device users where the electronic mail may be automatically generated by a simple drag and drop function by the user, and where the defined group of other electronic music marker device users may be updated is disclosed.

### FIELD OF THE INVENTION

The present invention relates to electronic data marking devices. More particularly, the present invention relates to method and system for exchanging data marks using electronic mail application.

### BACKGROUND OF THE INVENTION

With increase in portable electronic devices such as personal digital assistants (PDAs) and WAP (Wireless Application Protocol) enabled mobile telephone and so on, there has been a steady increase in these devices capable of performing more operations.

Sony Corporation and its U.S. subsidiary, Sony Electronics, Inc., introduced an electronic music marker device which is capable of “bookmarking” a music clip while being broadcast over a registered radio or television station, and is capable of recalling the information related to the bookmarked music clip such as the name of the song, the artist, the album containing the song and the like. Using the electronic music marker device, a user can conveniently access the music clip information that the user listened to on the radio at a later time without the need to memorize the information or wait hopefully for the disc jockey on the radio to provide that information. In this manner, if the user wants to, for example, purchase the music album which the user has marked using the electronic music marker device, the user can easily identify the necessary information related to the marked music clip from the e-marks provided by the electronic music marker device.

While the electronic music marker device provides the ability to bookmark broadcast music clips for accessing information related to the bookmarked music clips at a later point in time, for example, by accessing the user's e-marker.com account, it is configured to provide information related to bookmarked music clips that the account holder has bookmarked. As the market for electronic music marker device grows, it would be desirable for users to be able to exchange or share bookmarked music clip information by electronically transmitting playlists of bookmarked music clips among users of electronic music marker devices.

### SUMMARY OF THE INVENTION

In view of the foregoing, a method in one embodiment includes generating a recipient list, selecting one or more data mark information, and transmitting said one or more data mark information to one or more recipients in said recipient list.

A method of another embodiment includes displaying a recipient list window, receiving one or more input signals corresponding to one or more entry in said recipient list, displaying data mark information, displaying an application function icon, detecting a selection of the displayed data mark information and said application function icon, and transmitting an electronic message including said data mark information.

A method of a further embodiment includes initiating a mail application function, transmitting recipient information, and inputting a command for transmitting an electronic mail message including one or more data mark information.

A data mark sharing system of still another embodiment includes means for generating a recipient list, means for selecting one or more data mark information, and means for transmitting said one or more data mark information to one or more recipients in said recipient list.

A data mark information electronic mailing system of still yet another embodiment includes means for displaying a recipient list window, data mark information and an application function icon, and means for receiving one or more input signals corresponding to one or more entry in said recipient list, means for detecting a selection of the displayed data mark information and said application function icon, and means for transmitting an electronic message including said data mark information.

A data mark information sharing system of still a further embodiment includes means for initiating an electronic mail application function, means for transmitting recipient information, and means for inputting a command for transmitting an electronic mail message including one or more data mark information.

These and other features and advantages of the present invention will be understood upon consideration of the following detailed description of the invention and the accompanying drawings.

### BRIEF DESCRIPTION OF THE DRAWINGS

FIG. 1 illustrates an overall electronic music marker device emailer system in accordance with one embodiment;

FIG. 2 illustrates one embodiment of the electronic music marker device shown in FIG. 1;

FIG. 3 illustrates one embodiment of the user terminal shown in FIG. 1;

FIG. 4 illustrates one embodiment of the server terminal shown in FIG. 1;

FIGS. 5A-5C are illustrations of an electronic music marker device emailer system application procedure displayed at the user terminal in one embodiment;

FIGS. 6A-6B are illustrations of the electronic music marker device emailer system operation process in one embodiment displayed at the user terminal;

FIG. 7 is a flowchart illustrating one embodiment of the electronic music marker device emailer system;

FIG. 8 is a flowchart illustrating another embodiment of the electronic music marker device emailer system; and

FIG. 9 is a flowchart illustrating one embodiment of the message completion procedure of FIG. 8.

### DETAILED DESCRIPTION

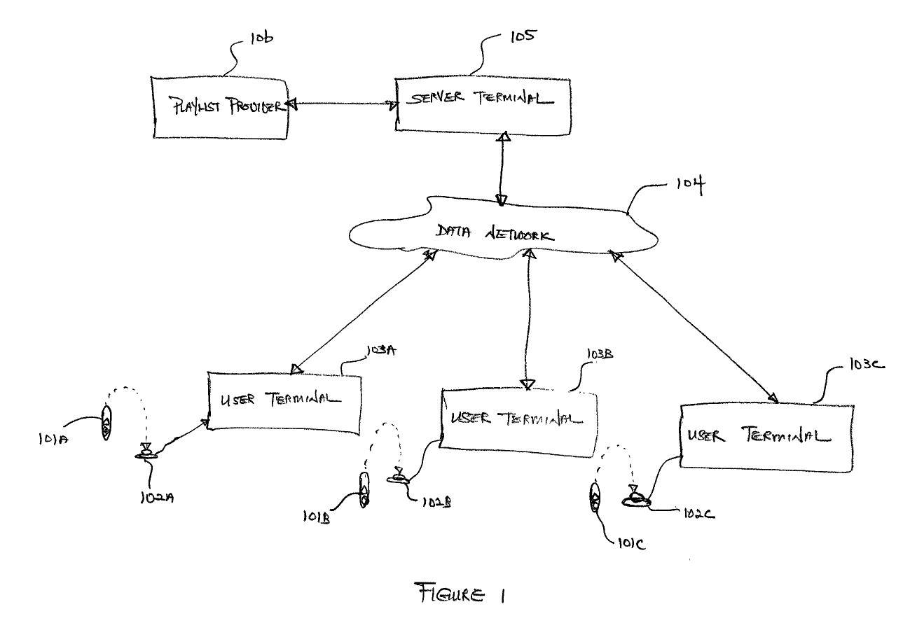

FIG. 1 illustrates an overall electronic music marker device emailer system in accordance with one embodiment. Referring to FIG. 1, electronic music marker device emailer system 100 includes a plurality of user terminals 103A-1 03C each connected to data network 104 such as the internet via connection protocols such as TCP/IP, Appletalk, using connection interface unit (not shown) such as a dial-up modem through an internet service provider (ISP), a broadband network such as a DSL or cable modem, a T1 or LAN connection, or any other means for connecting to the internet. Each user terminal 103A-103C is configured to connect to a respective electronic music marker device 101A-101C via a cradle type connection unit 102A-102C, and configured to receive, upon synchronization operation with the respective music marker devices 101A-101C, bookmark information stored in music marker devices 101A-101C.

In one embodiment, the bookmark information transmitted from music marker devices 101A-101C to the respective user terminals 103A-103C may include corresponding music marker device 101A-101C unique device identification code, the number of stored bookmarks, and corresponding date and time stamp for each stored bookmarks. Additional detailed information relating to the operation of the electronic music marker devices can be found in pending application Ser. No. 09/126,007 filed on Jul. 29, 1998 and application Ser. No. 09/401,105 filed on Sep. 22, 1999, both assigned to Sony Corporation, joint-assignee of the present application with Sony Electronics, Inc., a subsidiary of Sony Corporation, the disclosures of each of which are herein incorporated in their entirely by reference for all purposes.

Also shown in FIG. 1 is server terminal 105 connected to data network 104 for communicating with user terminals 103A-103C for data transfer. Moreover, as further shown in FIG. 1, server terminal 105 is coupled to playlist provider 106. Playlist provider 106 is configured to transmit playlist information corresponding to registered radio station broadcasts such as the title, artist and album information for the music broadcast from the registered radio station. In one aspect, playlist provider 106 may be configured to periodically transmit information related to the music broadcast from the registered radio stations over a predetermined period of time. For example, depending upon factors such as the target market for the registered radio station or the geographic location of the registered radio station, playlist provider 106 may be configured to transmit broadcast music clip information to server terminal 105 within ten minutes from the termination of the respective music broadcast, or alternatively, within 12 or 24 hours from a predetermined broadcast cutoff time such as 10 PM or midnight. Moreover, while playlist provider 106 is shown as communicating with server terminal 105 via a dedicated connection, within the scope of the present invention, server terminal 105 and playlist provider 106 may communicate via a connection through data network 104 for data transfer.

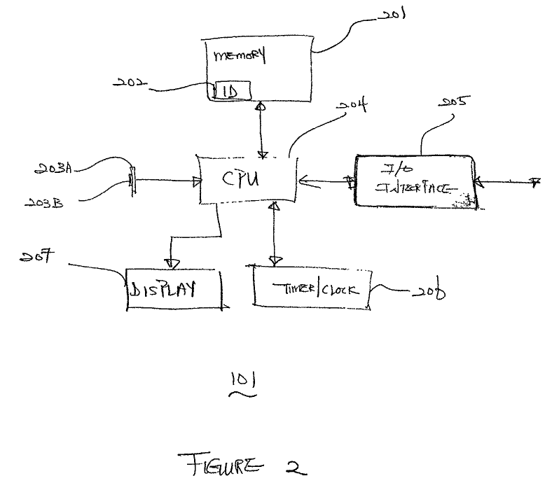

FIG. 2 illustrates one embodiment of the electronic music marker device shown in FIG. 1. Referring to FIG. 2, electronic music marker device 101 includes memory 201 such as a Random Access Memory (RAM) and a Read-Only Memory (ROM), and stored thereon is a unique device identification code 202 which can include a predetermined combination of letters or numbers, or a combination of both. In one embodiment, identification code 202 can include a thirteen-digit number which is unique to each bookmarking device and is pre-stored in the ROM portion of memory 201. It should be noted that the description of music marker device 101 set forth herein applies equally to each device 101A-101C shown in FIG. 1.

Further shown in FIG. 2 is controller (CPU) 204 which is configured to control the various components of marker integrated device 101 as related to the data marking device functionality such as display unit 207, input units 203A, 203B data marking buttons for bookmarking broadcast music clips over a registered radio or television station, or for bookmarking locations, input/output (I/O) interface unit 205, clock/timer 206, and memory 201. As can be seen from FIG. 2, upon receiving an input signal from a user of music marker device 101 via input units 203A, 203B, controller 204 may be configured to access the various components of device 101 depending upon the input command received from the user, to perform one or a plurality of processings, executing the input command of the user.

Referring back to FIG. 2, I/O interface 205 of music marker device 101 shown in FIG. 2 may be configured to, under the control of controller 204, interface with server terminal 105. Display unit 207 in accordance with one embodiment of the present invention may include a liquid crystal display (LCD), a plasma-type display, and the like, configured to display text or image data, or a combined text and image data. Furthermore, as discussed above, the input unit 203A, 203B may include spring-loaded type input buttons for operation by the user's finger. Alternatively, input unit 203A, 203B may include a touchpad-type screen integrated with display unit 207 for simultaneously inputting and displaying information, where the user can tap the pressure-sensitive screen using a stylus or the like to enter input commands. Timer/clock 206 of music marker device 101 in accordance with one aspect of the present invention may be configured to provide actual time information as well as generate an elapsed time information depending upon the input command from the user under the control of controller 204.

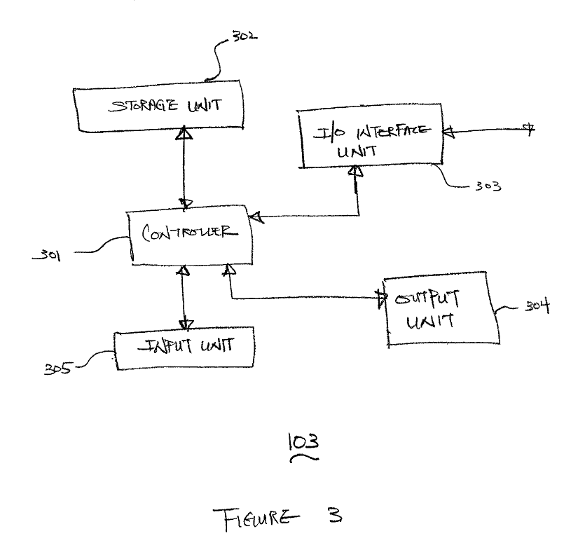

FIG. 3 illustrates one embodiment of the user terminal shown in FIG. 1. Referring to FIG. 3, user terminal 103 in one embodiment may include controller 301, storage unit 302, I/O interface unit 303, input unit 305, and output unit 304. Storage unit 302 of user terminal 103 may include one or more of an internal or an external storage device such as a hard disc drive (HDD), a CD-RW drive, or a zip drive. Input unit 305 of user terminal 103 may include one of or a combination of a keyboard, a mouse, a touchpad input device and a voice-recognition type input terminal including a microphone with corresponding software installed in user terminal 103 for performing input operations by voice commands. Controller 301 is coupled to input unit 305 and accordingly, may be configured to process the input data received from input unit 305. Storage unit 302 is similarly coupled to controller 301, and may be configured to store inputted data received from input unit 305 or other data received by user terminal 103.

Referring back to FIG. 3, I/O interface unit 303 in one embodiment may be coupled to controller 301, and may be configured to interface with other user terminals 103 in the network or to communicate with server terminal 105. In one embodiment, I/O interface circuit 303 of user terminal 103 may include a communication port configured to connect to the date network 104 such as the internet via connections such as, but not limited to, a modem dial-up through an internet service provider (ISP), a DSL or cable modem-type connection, and a T1, IDSN or LAN type connection. Communication port integrated in I/O interface unit 303 may include, among others, one of a USB port, a serial port, a parallel port, an IEEE 1394 communication port, a IrDA communication port, and a Bluetooth enabled communication port.

Referring again to FIG. 3, output unit 304 of user terminal 103 may include a display terminal and speakers for outputting graphics, video, text and audio data. In this manner, user terminal 103 in one embodiment may be configured to communicate with server terminal 105 over the data network 104.

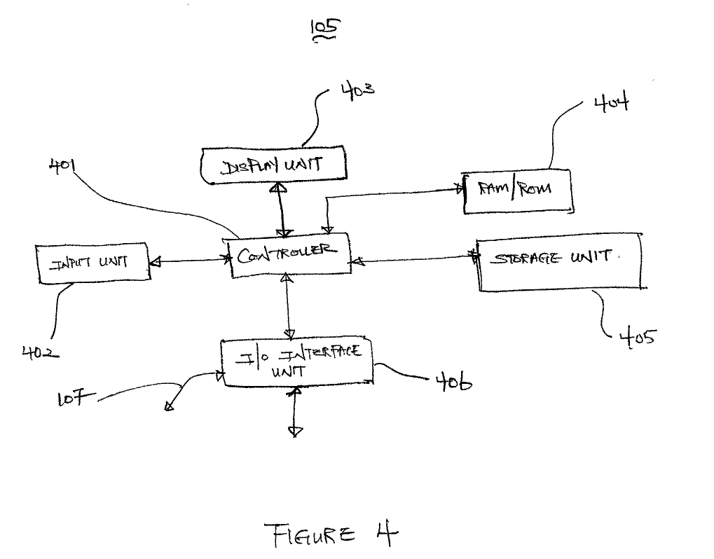

FIG. 4 illustrates one embodiment of the server terminal shown in FIG. 1. Referring to FIG. 4, server terminal 105 includes display unit 403, input unit 402, controller 401, input/output (I/O) interface unit 406, memory (RAM/ROM) 404, and storage unit 405. Display unit 403 may be configured to display various information including the status of server terminal 105 connection, data transfer processing status, data upload information, and any other information related to the operation of server terminal 105.

Input unit 402 of server terminal 105 may be configured to provide input means for operations such as server terminal maintenance, data backup, data query and so on. As can be seen, both display unit 403 and input unit 402 are coupled to controller 401. In one embodiment, controller 401 may be configured to control the display of information on display unit 403 in accordance with input operations received from input unit 402. Alternatively, server terminal 105 may exclude display unit 403.

Referring back to FIG. 4, controller 401 of server terminal 105 is further coupled to memory 404, storage unit 405 and I/O interface unit 406. In one embodiment, controller 401 may be configured to control data access, retrieval and updating of the stored data in storage unit 405. Moreover, controller 401 may further be configured to control the operation of I/O interface unit 406 which communicates with other terminals connected in the network over data network 104. In one embodiment, I/O interface circuit 406 may include a communication port configured to connect to other terminals in the network via connections such as, but not limited to, a modem dial-up through an internet service provider (ISP), a DSL or cable modem-type connection, and a T1, ISDN or LAN type connection. Communication port integrated in I/O interface circuit 406 may include, among others, one of a USB port, a serial port, a parallel port, an IEEE 1394 communication port, a IrDA communication port, and a Bluetooth enabled communication port.

Referring again to FIG. 4, storage unit 405 of server terminal 105 may include internal or external storage devices such as a hard disc drive (HDD), a CD-RW drive, or a zip drive. In one embodiment, storage unit 405 may be configured to store a variety of data received by server terminal 105 and processed by server terminal 105. In particular, storage unit 405 may include a plurality of databases such as user account database, playlist database, and user playlist database. User account database may be configured to store information related to the registered users of the electronic music marker device system such as, for example, user name, address, account name, account password, and account status, as well as user specific application information such as user defined friend email group list. Playlist database may be configured to store playlists for each registered radio station broadcasts periodically received from playlist provider 106. Additionally, user playlist database may be configured to store music clip broadcast playlists corresponding to the user's bookmarks.

As further shown in FIG. 4, controller 401 is coupled to memory 404 for accessing software and drivers for performing the various functions and processes of server terminal 105 for the electronic music marker device emailer system. Indeed, in one embodiment, the electronic music marker device emailer system may be embodied as a computer program developed using an object oriented language that allows the modeling of complex systems with modular objects to create abstractions that are representative of real world, physical objects and their interrelationships. However, it would be understood by one of ordinary skill in the art that the various embodiments as described herein may be implemented in many different ways using a wide range of programming techniques as well as general purpose hardware systems or dedicated controllers.

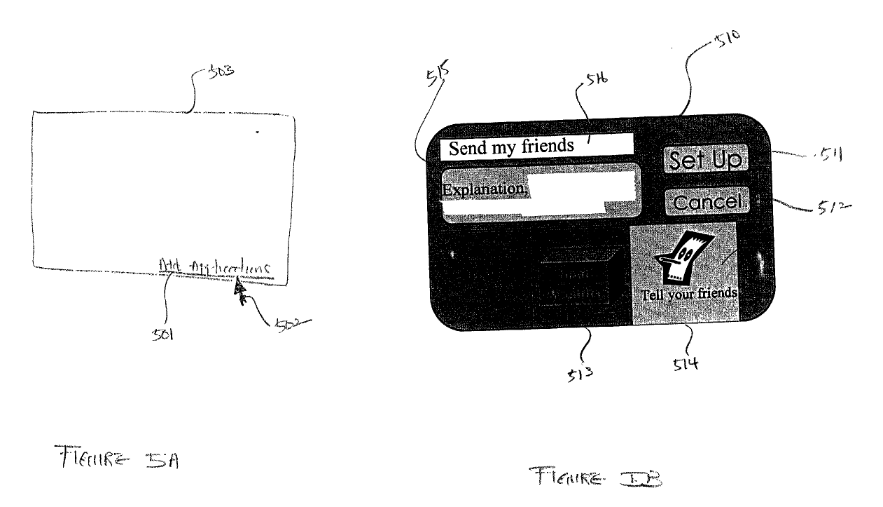

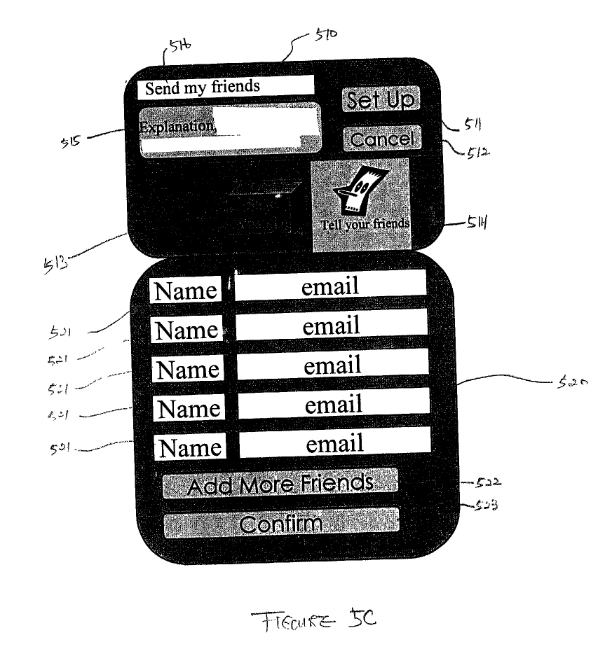

FIGS. 5A-5C are illustrations of an electronic music marker device emailer system application procedure displays at the user terminal in one embodiment. Referring to FIG. 5A, output unit 304 of user terminal 103 includes a display terminal 503 such as a cathode ray tube or LCD monitor for displaying user's electronic music marker device account information once logged into e-marker.com server terminal for accessing the user's bookmarked music clip information. More specifically, once the user is logged into e-marker.com server terminal and accesses the user's electronic music marker device account, in one embodiment, displayed on user terminal 103 output unit 304 may be an “Applications” function 501 displayed, for example, in hypertext link format. Using an input device such as a computer mouse (displayed as a cursor 502) of input unit 305 at user terminal 103, the user may select the Applications function 501 by a single or double click of the input device.

Referring to FIG. 5B, when the user operates the input device 502 to initiate the applications function 501 displayed on display terminal 503, in one embodiment, a pop-up window 510 corresponding to applications function 501 may be displayed on display terminal 503. Alternatively, detailed information corresponding to the selected applications function 501 may be displayed on display terminal 503 as a screen refresh rather than a foreground pop-up window.

Referring back to FIG. 5B, the displayed pop-up window 510 may include, in one aspect, a plurality of control buttons such as set up button 511 and cancel button 512, which may be configured to initiate the set up procedure of the applications displayed on the pop-up window, or to cancel the applications function 501 and return to the previous page viewed on the user's e-marker.com account, respectively. Also shown in FIG. 5B is a plurality of predetermined applications including send wishlist function 513 and tell your friends function 514.

Furthermore, an explanation area 515 may be included in the displayed pop-up window 510 which may be configured to display (as text or graphically), the application selected by the user, while user defined application area 516 may be included in the displayed pop-up window 510 for allowing the user to define and input a user specified name for the various application functions displayed in pop-up window 510. In one aspect, the text and/or graphical explanation displayed in explanation area 515 may dynamically change based on the selected (or preselected) application in pop-up window 510. More specifically, by moving the input device (such as cursor 502 (FIG. 5A) corresponding to the computer mouse at user terminal 103) over the area defined for the respective applications (for example, over the substantially square area defining tell your friends function 514), a corresponding explanation may be displayed in explanation area 515 prior to the user's selection of tell your friends function 514.

Referring now to FIGS. 5B-5C, when the user selects set-up button 511, in one embodiment, detailed function menu 520 may be configured to be displayed as a drop down menu 510 as shown in FIG. 5C. In one embodiment, in the case of pop-up window 510 shown in FIG. 5B, detailed function menu 520 may be an extension of the pop-up window 510, thus being displayed in the foreground of the display terminal 503. Alternatively, detailed function menu 520 may be displayed adjacent to pop-up window 510 or as a separate display window on display terminal 503.

Referring back to FIG. 5C, detailed function menu 520 may include, in one embodiment, a plurality of name-email field pairs 521 corresponding to the names and email addresses of user's intended recipients corresponding to tell your friends function 514. Moreover, detailed function menu 520 may also include add more friends button 522 which is configured to allow the user to add additional names and corresponding email addresses of the user's intended recipients beyond the five entries for the name-email field pairs 521 shown in FIG. 5C, while confirm button 523 may be configured to confirm the user's entry in the respective name-email field pairs 521.

In one embodiment, upon execution of confirm button 523 by the user, user terminal 103 may be configured to transmit the entered name-email information to server terminal 105 to store the user specified name-email information for the user in the respective location in storage unit 405 (FIG. 4) of server terminal 105. Alternatively, the user specified name-email information provided in name-email field pairs 521 may be locally stored in user terminal 103 (for example, in memory 201) such that, when the user initiates the respective applications function such as tell your friends function 514, server terminal 105 may instruct user terminal 103 to retrieve the locally stored name-email field pairs 521 to allow execution of tell your friends function 514. Alternatively, server terminal 105 may be configured to retrieve the locally stored name-email field pairs 521 from user terminal 103 and initiate the appropriate function such as tell your friends function 514.

Referring back to FIG. 5C, when the user has completed entering information in name-email field pairs 521 for the selected function and executes confirm button 523, pop-up window 510 and detailed function menu 520 may, in one embodiment, be configured to close from display terminal 503, returning the user's viewing page on user terminal to the user's e-marker.com account. In this manner, in one embodiment, the users of electronic music marker devices may conveniently set up a list of recipients (including names and corresponding email addresses) for transmitting the users bookmarked music clip information such as the user's playlist information as discussed in further detail below. Moreover, the user may conveniently add, delete and/or revise the list of recipients at any time which the user has accessed the user's e-marker.com account.

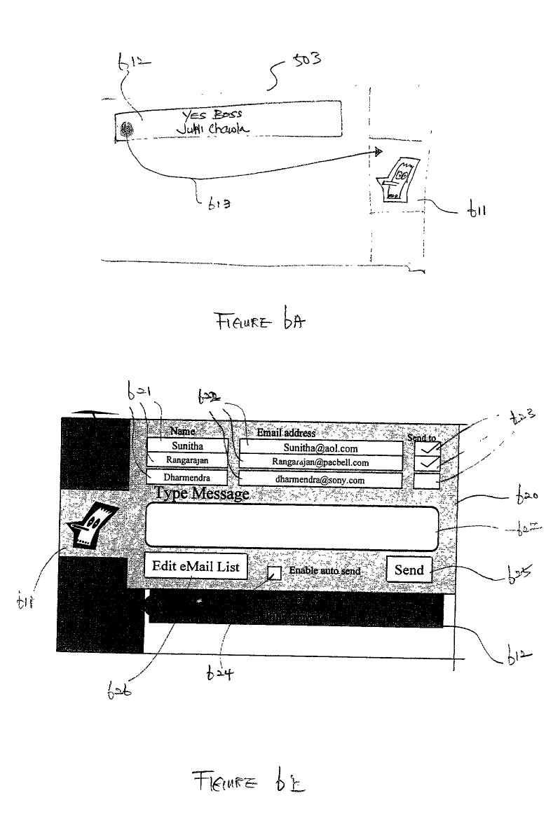

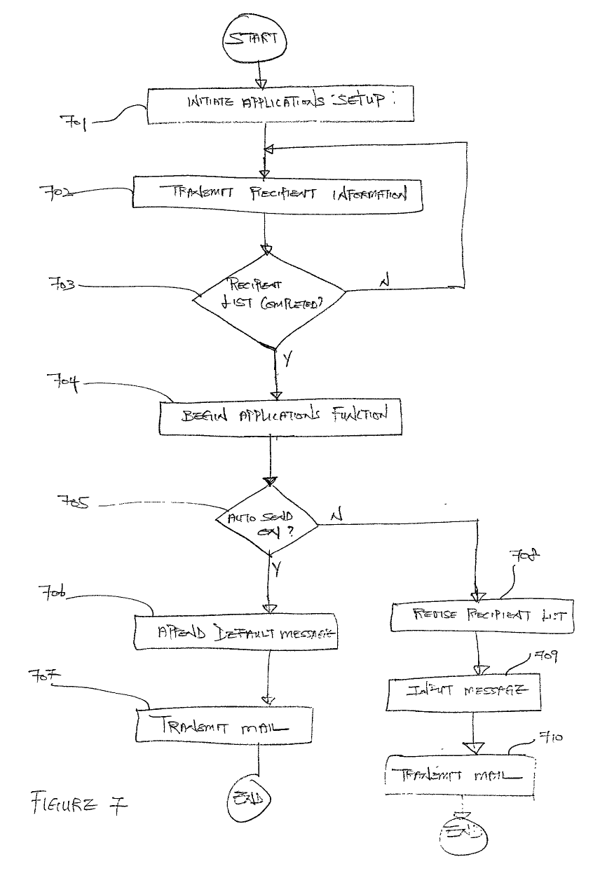

FIGS. 6A-6B are illustrations of the electronic music marker device emailer system operation process displayed at the user terminal in one embodiment. Referring to FIG. 6A, upon completing the electronic music marker device emailer recipient set up process as discussed above and when the user returns to the user's e-marker.com account, displayed on display terminal 503 of user terminal 103 are information corresponding to the user's bookmarked music clips. For example, as shown in FIG. 6A, a combined text and graphical illustration of the bookmarked music clip information 612 is displayed. Also displayed are application functions such as tell your friends function 514 (FIG. 5B-5C) as a graphical icon (two-dimensional or three-dimensional) 611.

When the user, using an input device such as a computer mouse and the like, to perform a drag-and-drop operation (as shown by arrow 613) to drag and drop bookmarked music clip information 612 into (or substantially over) the graphical icon 611 representing the application function, for example, tell your friends function 514 (FIG. 5), electronic mail message window 620 may be configured to be displayed along with graphical icon 611 of tell your friends function as shown in FIG. 6B. In one embodiment, upon execution of the drag-and-drop operation by the user as discussed above, the displayed screen column including graphical icon 611 for the applications function may be configured to visually slide across the display screen of display terminal 503 (FIG. 6A) and electronic mail message window 620 is displayed.

Referring to FIG. 6B, electronic mail message window 620 in one aspect may include a plurality of name fields 621 and corresponding email address fields 622. Additionally, send-to field 623 may be provided in electronic mail message window 620 for each name (621)—email address (622) pair. In one embodiment, electronic mail message window 620 may be displayed with name fields 621 and corresponding email address fields 622, each of which corresponding to the user designated name-email field pairs 521 as discussed above. Furthermore, send-to field 623 is displayed corresponding to each name field 621—email address field 622 pairs. In one embodiment, the user may have the option of designating one or more send-to fields 623 for the recipients of the user's electronic mail message. Alternatively, the user may select enable auto send button 624 to transmit the generated electronic mail message to all of the recipients provided in name field 621—email address field 622 pairs. In the latter approach, the when the user performs the drag and drop operation as indicated by arrow 613 (FIG. 6A), the electronic mail message including the user's bookmarked music clip information is automatically transmitted to each of the recipients corresponding to the name field 621—email address field 622 pairs.

Referring back to FIG. 6B, also shown is send button 625 which, when operated by the user, is configured to transmit the generated electronic mail message to the recipients corresponding to the name field 621—email address field 622 with designated (or “checked”) send-to field 623. Moreover, the user may revise or edit the recipient list by operating edit email list button 626, in which case, pop-up window 510 and detailed function menu 520 is displayed on user terminal 103 as discussed above. Also shown in FIG. 6B is a message box 627 in which, the user may optionally include a message for transmission to the recipients. The message may be input by the user or alternatively, may include a pre-registered or formatted message. In one aspect, if the user does not input a message in message box 627, a default message generated by server terminal 105 may be provided in message box 627. It can be further seen from FIG. 6B that bookmarked music clip information 612 (FIG. 6A) may be displayed in the generated electronic mail message window 620. Indeed, bookmarked music clip information 612 upon which the user has performed the drag and drop operation (arrow 613) as discussed above in conjunction with graphical icon 611 shown in FIG. 6A representing tell your friends function 514 (FIG. 5B-5C) may be provided in the message window 620 for transmission to the user's designated recipients. Furthermore, while only one bookmarked music clip information 612 is shown in FIGS. 6A-6B, within the scope of the present invention, multiple bookmarked music clip information may be provided in each generated electronic mail message window 620 for transmission.

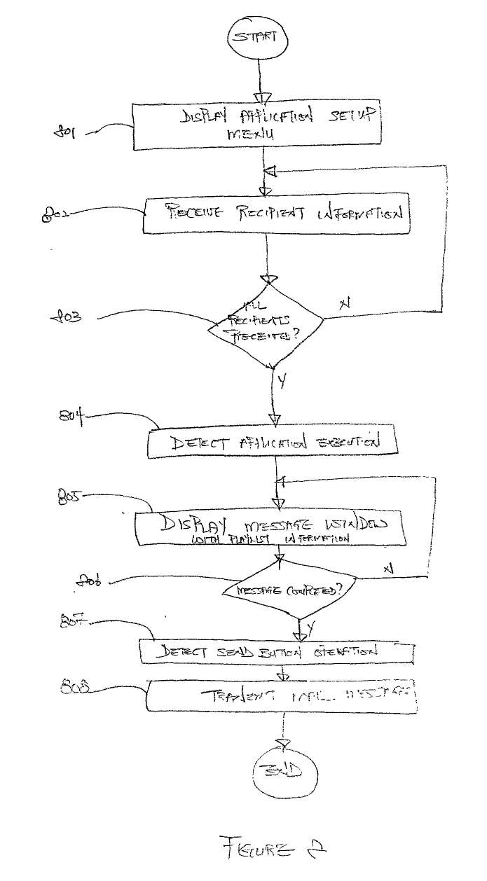

FIG. 7 is a flowchart illustrating one embodiment of the electronic music marker device emailer system. Referring to FIG. 7, at step 710, applications setup step is initialized, and at step 702, recipient information is transmitted. Thereafter at step 703, it is determined whether the recipient list comprising, in one aspect, the recipient information transmitted at step 702, is complete. If at step 703 it is determined that the recipient list is not completed, then the procedure returns to step 702.

On the other hand, if at step 703 it is determined that the recipient list is completed, then at step 704, applications function is initiated. In other words, upon completing the plurality of name-email field pairs 521 (FIG. 5C) representing the user's intended recipients (shown, for example, by name and corresponding email address pairs), the electronic mail message window 620 (FIG. 6B) is displayed. Moreover, the applications function is initiated at step 704, among others, upon detection of, for example, the user's drag and drop operation of bookmarked music clip information such as the user's playlist information into the applications function icon displayed in user terminal 103.

Referring back to FIG. 7, at step 705, it is determined whether auto send function is turned on, i.e., whether enable auto send button 624 is activated. If it is determined at step 705 that the auto send function is turned on, then at step 706, default message is retrieved and appended to the mail message window, and the mail message including the user's designated playlist information (corresponding to the user's bookmarked music clip information) is transmitted. On the other hand, if at step 705 it is determined that the auto send function is not on, then at step 708, recipient list is revised (to include additional recipients and/or delete existing recipients), and at step 709 the user's message is input and displayed in the mail message window 620 (FIG. 6C). Thereafter at step 710, the mail message is transmitted to the listed recipients including the user's playlist information corresponding to the user's bookmarked music clip information.

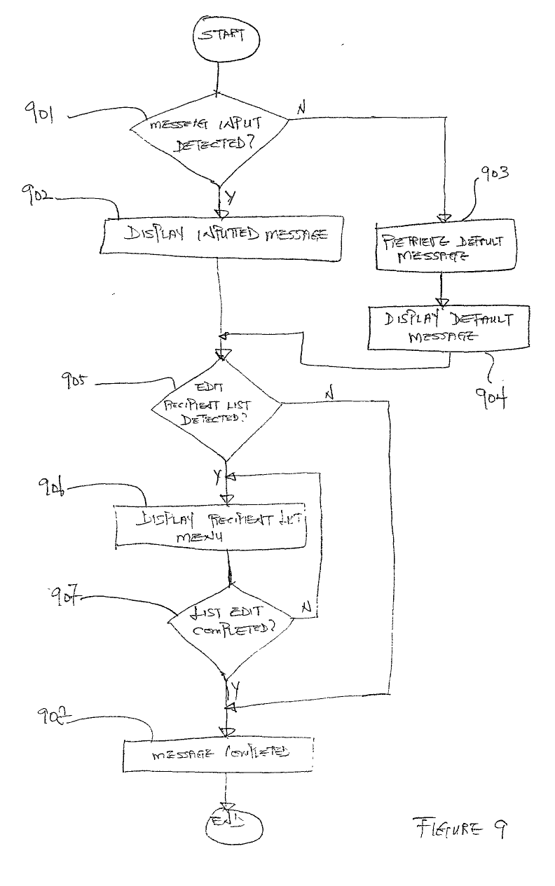

FIG. 8 is a flowchart illustrating another embodiment of the electronic music marker device emailer system. Referring to FIG. 8, at step 801, application setup menu is displayed on user terminal 103 (FIG. 1), and at step 802, recipient information is received. At step 803 it is determined whether all of the intended recipient information from the user is received. If at step 803 it is determined that not all of the recipient information is received, then the procedure returns to step 802 and continues receiving recipient information.

On the other hand, if at step 803 it is determined that all of the recipient information is received, the procedure waits until application execution is detected at step 804. In one aspect, the detected application execution at step 804 may include the user's drag and drop operation of the user's bookmarks 15 music clip information at user terminal 103 into a graphical icon representing the application (such as the electronic music marker device emailer icon 514 (FIG. 5C) representing the tell your friends function).

Referring back to FIG. 8, upon detecting the application execution at step 804, the corresponding message window with the user's designated playlist information is displayed at step 805. Thereafter at step 806, it is determined whether the electronic mail message is completed. If it is determined that the electronic mail message has not been completed, then the procedure returns to step 805. Otherwise, if it is determined that the mail message is completed at step 806, then at step 807, send operation is detected and the generated electronic mail message including the user's playlist information is transmitted to each of the recipients in the recipient list of the message. In one aspect, the send operation is detected at step 807 upon detecting the user's operation of the send button 625 (FIG. 6B), for example.

FIG. 9 is a flowchart illustrating one embodiment of the message completion procedure of FIG. 8. More specifically, FIG. 9 is a flowchart illustration of the message completion step 806 of FIG. 8. Referring to FIG. 9, at step 901, it is determined whether a message input such as user's textual message for inclusion in the electronic mail message transmission is received from user terminal input unit 305 (FIG. 3). If at step 901 user message input is detected, then at step 902, the inputted message received from user terminal input unit 305 is displayed in mail message window 627 (FIG. 6B). On the other hand, if no message input is detected at step 901, then at step 903, a default message may be retrieved and displayed in message window 627 at step 904. In one embodiment, the default message may include a predetermined message generated by server terminal 105 to be included with the mail message transmission to the user's recipients, and may include, for example, text and/or graphical information related to the user (the sender) such as the sender's name and/or email address.

Referring back to FIG. 9, at step 905 it is determined whether recipient list edit function is initiated. As discussed above, the user may initiate the edit of the recipient list by operation of, for example, edit email list button 626 (FIG. 6B) displayed in message window 620. If at step 905 edit recipient list is detected, then at step 906, the recipient list menu is displayed at user terminal. The displayed recipient list menu in one embodiment may include detailed function menu 520 (FIG. 5C) displayed on user terminal 103 to allow the user to add additional recipients for the particular message to be transmitted or to delete existing recipients for the particular message. In one aspect, user edits to the recipient list at step 906 may be configured to provide a global modification to the user's recipient list which is stored either at server terminal 105 or locally at user terminal 103 and accessed by server terminal 105.

Referring back to FIG. 9, at step 907 it is determined whether the recipient list edit is completed, and if not, the procedure returns to step 906. On the other hand, if the recipient list edit operation is completed at step 907, it is determined that the message is completed at step 908, thus completing the procedure of step 806 of FIG. 8. Furthermore, if at step 905 it is determined that recipient list edit operation is not detected, then at step 908 it is likewise determined that the message is completed, thus proceeding to step 807 of FIG. 8 for transmitting the completed electronic mail message to the user's recipients including the user's playlist information corresponding to the user's bookmarked music clip information.

In the manner described above, in accordance with the various embodiments of the present invention, users of electronic music marker devices may conveniently share playlist information corresponding to the bookmarked music clips with other electronic music marker device users. More specifically, electronic music marker device users may generate and transmit electronic mail messages including user's bookmarked music clip information (such as playlist information) to other users of electronic music marker devices by simple drag and drop operations of the playlist information displayed at user terminals, for example. Moreover, the users may conveniently generate and maintain a recipient list including, for example, names and email addresses of other electronic music marker device users which may be automatically retrieved upon the user's initiation of the electronic music marker device emailer function.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A method, comprising:
generating a recipient list;
selecting one or more data mark information; and
transmitting said one or more data mark information to one or more recipients in said recipient list.

2. The method of claim 1 wherein said recipient list includes one or more of a name of a recipient and an email address corresponding to each of said one or more names.

3. The method of claim 1 wherein the selecting step includes performing a drag and drop operation.

4. The method of claim 3 wherein said drag and drop operation includes:
selecting an icon representing said one or more data mark information;
dragging said selected icon over an application display; and
deselecting said dragged icon substantially over said application display.

5. The method of claim 4 wherein said icon includes a combined graphical and text display representation.

6. The method of claim 4 wherein said application display includes an electronic mail application display.

7. The method of claim 4 wherein transmitting step includes initiating an application function corresponding to said application display for transmitting said one or more data mark information.

8. The method of claim 1 further including storing said recipient list.

9. The method of claim 1 further including modifying said recipient list.

10. The method of claim 1 further including appending a message text to said one or more data mark information transmission.

11. The method of claim 1 wherein said data mark information includes a playlist information corresponding to one or more bookmarked music clip broadcasts.

12. The method of claim 1 wherein said transmitting step includes generating an electronic mail including said data mark information and transmitting said generated electronic mail to said one or more recipients.

13. A method, comprising:
displaying a recipient list window;
receiving one or more input signals corresponding to one or more entry in said recipient list;
displaying data mark information;
displaying an application function icon;
detecting a selection of the displayed data mark information and said application function icon; and
transmitting an electronic message including said data mark information.

14. The method of claim 13 wherein said recipient list window includes one of a pop-up window display and a drop down window display.

15. The method of claim 13 wherein said one or more input signals includes one or more of a name and electronic mail address pair.

16. The method of claim 13 wherein said data mark information includes a playlist information corresponding to one or more bookmarked broadcast music clips.

17. The method of claim 13 wherein said displaying data mark information step includes generating a combined graphical and text representation corresponding to said data mark information.

18. The method of claim 13 wherein said message transmitting step includes automatically transmitting said message after said detecting step.

19. The method of claim 13 wherein said message transmitting step includes:
displaying a message window;
detecting a transmit command; and
transmitting said electronic message.

20. The method of claim 19 wherein said data mark information in said transmitted message includes one or more playlist information each corresponding to a bookmarked music clip broadcast.

21. The method of claim 13 further including storing said recipient list.

22. The method of claim 13 wherein said detecting step includes detecting a drag and drop operation of said data mark information.

23. A method, comprising:
initiating a mail application function;
transmitting recipient information; and
inputting a command for transmitting an electronic mail message including one or more data mark information.

24. The method of claim 23 wherein said one or more data mark information includes one or more playlist information each corresponding to a bookmarked broadcast music clip.

25. The method of claim 23 further including initiating an auto transmit function.

26. The method of claim 25 further including appending a default message to said electronic mail message.

27. The method of claim 23 wherein said recipient information transmitting step includes revising a recipient list.

28. The method of claim 27 wherein said recipient list includes one or more of a name and an electronic mail address pairs.

29. A data mark sharing system, comprising:
means for generating a recipient list;
means for selecting one or more data mark information; and
means for transmitting said one or more data mark information to one or more recipients in said recipient list.

30. The system of claim 30 wherein said recipient list includes one or more of a name of a recipient and an email address corresponding to each of said one or more names.

31. The system of claim 29 wherein the selecting means includes means for performing a drag and drop operation.

32. The system of claim 31 wherein said means for performing said drag and drop operation includes:
means for selecting an icon representing said one or more data mark information;
means for dragging said selected icon over an application display; and
means for deselecting said dragged icon substantially over said application display.

33. The system of claim 32 wherein said icon includes a combined graphical and text display representation.

34. The system of claim 32 wherein said application display includes an electronic mail application display.

35. The system of claim 32 wherein transmitting means includes means for initiating an application function corresponding to said application display for transmitting said one or more data mark information.

36. The system of claim 29 further including means for storing said recipient list.

37. The system of claim 29 further including means for modifying said recipient list.

38. The system of claim 29 further including means for appending a message text to said one or more data mark information transmission.

39. The system of claim 29 wherein said data mark information includes a playlist information corresponding to one or more bookmarked music clip broadcasts.

40. The system of claim 29 wherein said transmitting means includes means for generating an electronic mail including said data mark information and transmitting said generated electronic mail to said one or more recipients.

41. A data mark information electronic mailing system, comprising:
means for displaying a recipient list window, data mark information and an application function icon;
means for receiving one or more input signals corresponding to one or more entry in said recipient list;
means for detecting a selection of the displayed data mark information and said application function icon; and
means for transmitting an electronic message including said data mark information.

42. The system of claim 41 wherein said recipient list window includes one of a pop-up window display and a drop down window display.

43. A data mark information sharing system, comprising:
means for initiating an electronic mail application function;
means for transmitting recipient information; and
means for inputting a command for transmitting an electronic mail message including one or more data mark information.

44. The system of claim 43 wherein said one or more data mark information includes one or more playlist information each corresponding to a bookmarked broadcast music clip.
